(19) United States
(12) Patent Application Publication
(10) Pub. No.: US 2011/0220740 A1
(43) Pub. Date: Sep. 15, 2011

(54) PRESSURE CONTROL VALVE

(76) Inventors: Alois Moser, Novi (DE); Johann Schardax, Linz (AT); Peter Luckeneder, Waldingl (AT); Andreas Poelzl, Krems (AT)

(21) Appl. No.: 12/532,325

(22) PCT Filed: Mar. 17, 2008
(86) PCT No.: PCT/EP08/53140

§ 371 Date: Mar. 24, 2011

(30) Foreign Application Priority Data
Mar. 21, 2007 (DE) 10 2007 013 525.6

(51) Int. Cl. B05B 1/30

(52) U.S. Cl. 239/570

(57) ABSTRACT

The invention relates to a pressure control valve, particularly for a high-pressure accumulator body of a fuel injection system. The pressure control valve includes a housing and an armature assembly having an armature plate and an armature pin. The armature plate and an end surface of the housing delimit a volume that can be filled with medium taken from the high-pressure accumulator. The volume is reduced by a fill volume.

### PRIOR ART

DE 102 14 084 A1 relates to an adjustable pressure control valve for fuel injection systems. The fuel injection system includes a high-pressure accumulator that is acted on with fuel at high pressure by means of a high-pressure delivery unit and supplies fuel to fuel injectors. The high-pressure delivery unit is associated with a pressure control valve that is situated between a high-pressure side and a low-pressure side and includes a valve element that can be triggered by means of an electric actuator. The pressure control valve includes a housing component that has a deformable region via which it is possible to adjust a gap L between surfaces of an electrically triggerable actuator device during installation of the pressure control valve in a receiving body.

DE 102 22 895 A1 relates to a high-pressure accumulator for fuel injection systems with an integrated pressure control valve. The high-pressure accumulator is acted on with fuel at high pressure by means of a high-pressure delivery unit and in turn supplies fuel to fuel injectors. The fuel injection system includes a pressure control valve that is situated between a high-pressure side and a low-pressure side and is able to actuate a valve element. The pressure control valve is actuated by means of an electric actuator. With one end surface, the pressure control valve delimits the low-pressure region in the high-pressure accumulator and is sealed by means of a seal on the low-pressure side.

Pressure control valves are used in an extremely wide variety of applications and as illustrated above in connection with DE 102 14 084 A1 and DE 102 22 895 A1, are used in (common rail) fuel injection systems. These pressure control valves have discontinuities and instabilities in the pressure/flow characteristic map and in their control range. In particular, the return pressure also exerts a powerful influence on the controllability and the achievable control quality of the pressure control valves known from the prior art.

### DISCLOSURE OF THE INVENTION

The object underlying the present invention is to produce an improved pressure control valve that more robustly resists the occurrence of instability, particularly due to the influence of constant or varying pressures on the low-pressure side (return pressure, backpressure).

The invention proposes reducing a volume, which is between a magnet armature and a flat housing surface and which is filled with the medium, for example fuel, discharged from the high-pressure side. This improves the stability of the pressure control valve, particularly in the presence of an elevated backpressure, since the smaller volume reduces the effective hydraulic forces that cause the instabilities that occur in the previously used pressure control valves known from the prior art. In order to reduce the volume—which influences the pressure/flow characteristic diagram of a pressure control valve, receives the influx of the discharged quantity, and is the place in which the hydraulic forces occur—and to be able to embody it as before despite the small residual air gap, the volume between the magnet armature and the above-mentioned flat housing surface is filled with a nonmagnetic material. This further increases the robustness of the resistance to the occurrence of instabilities.

The filling of the residual air gap between the magnet armature and the above-mentioned flat housing surface of the pressure control valve, particularly of the magnet core that contains the magnetic coil, is achieved for example by applying or inserting a film. It is also possible to apply a coating both to the end surface of the armature oriented toward the flat housing surface and to the flat housing surface itself. In the embodiment proposed according to the invention, a decoupling is produced between the volume around the armature plate of the armature assembly of the pressure control valve and the volume into which the medium, e.g. fuel at system pressure, is discharged from the high-pressure region.

The pressure control valve proposed according to the invention is distinguished from the pressure control valves known from the prior art, as briefly outlined above, in that on the one hand, there is a reduction in the volume between the magnet armature and the flat housing surface into which the medium discharged from the high-pressure side flows and/or on the other hand, this already reduced volume between the magnet armature and the flat housing surface is filled with a nonmagnetic material. This means that in the ideal case, the reduced volume between the flat housing surface and the flat side of the magnet armature becomes zero when the valve is closed, enabling a significant reduction of instabilities.

### BRIEF DESCRIPTION OF THE DRAWINGS

The invention will be explained in greater detail below in conjunction with the drawings.

FIG. 1 shows a pressure/flow characteristic map of a pressure control valve according to the prior art in the presence of a backpressure of approximately 5 bar,

FIG. 2 shows the pressure/flow characteristic map of a pressure control valve proposed according to the invention in the presence of a backpressure of between 5 and 6 bar, and

FIG. 3 is a section through the pressure control valve proposed according to the invention.

FIG. 1 shows a pressure/flow characteristic map for a pressure control valve according to the prior art.

FIG. 1 shows a pressure/flow characteristic map 10 in which the pressure, i.e. the system pressure with which a high-pressure accumulator (common rail) of a high-pressure accumulator injection system is acted on, is plotted over the flow through the pressure control valve in 1/h. For constant pressure control valve flows, different characteristic diagram curves (pressure over flow) 12 occur, which are each characterized by a region in which an instability 14 occurs. The instability 14 is characterized by the fact that for a first operating point A and a second operating point B, a flow value is associated with several system pressure values, i.e. the pressure control valve is in an undefined state.

### EMBODIMENTS

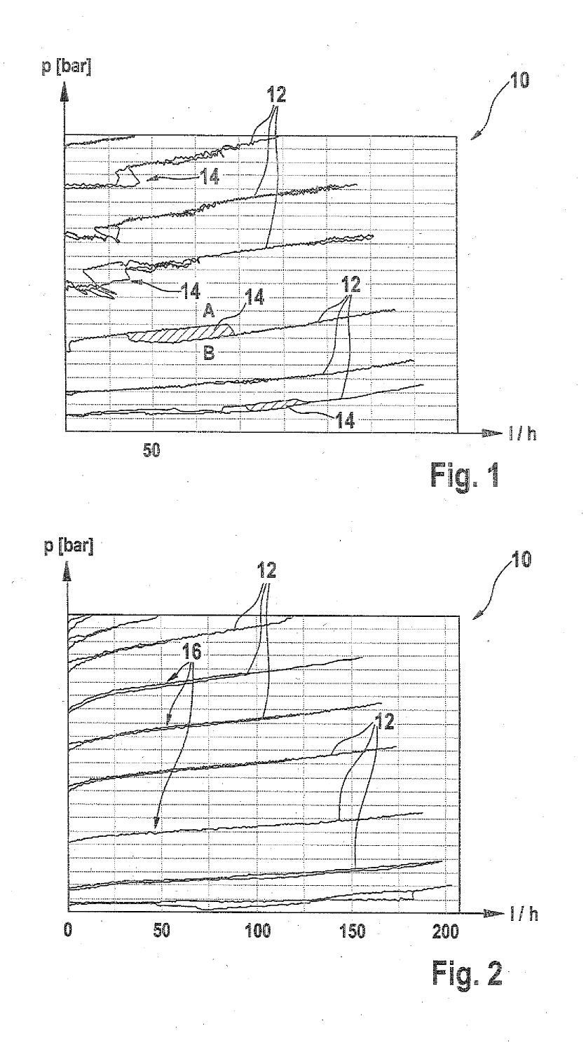

FIG. 2 shows a pressure/flow characteristic map 10, which has been plotted for a pressure control valve proposed according to the invention. Analogous to the depiction according to FIG. 1, characteristic diagram curves 12 are shown, but by contrast with the instabilities 14 of the characteristic diagram curves 12 shown in FIG. 1, these are characterized by smooth curves 16. The characteristic diagrams have continuous, steady curves so that with a backpressure of at least 5 bar, a value for the system pressure p is associated with essentially one value for a corresponding flow in 1/h. This means that the flow quantity for each system pressure is exactly defined in accordance with the characteristic diagram curves 12, i.e. the pressure control valve proposed according to the invention can be adjusted in a significantly more stable fashion than the pressure control valve known from the prior art, whose instabilities are evident in the characteristic diagram curves 12 from FIG. 1.

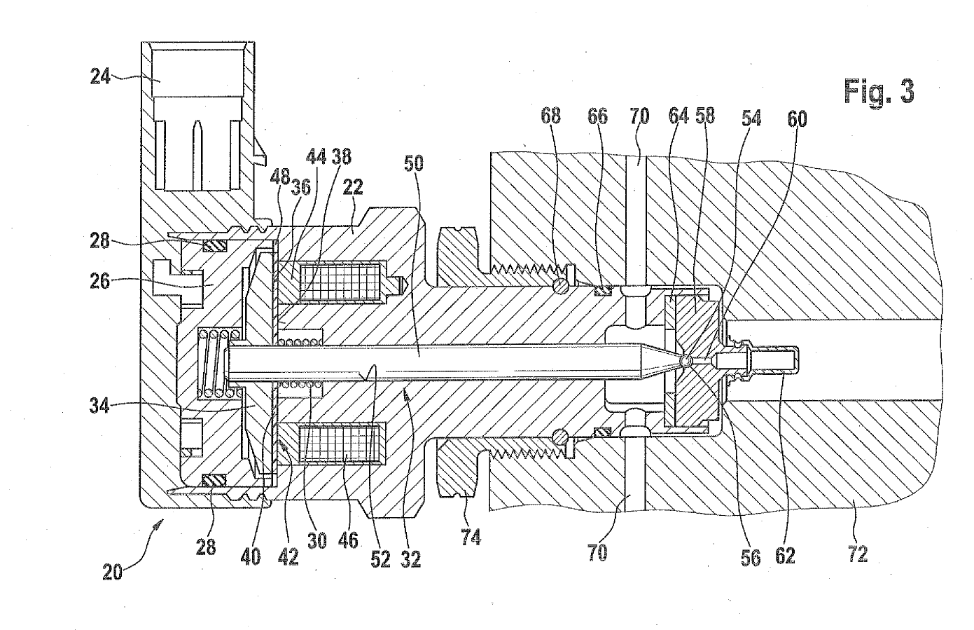

FIG. 3 shows a section through the pressure control valve proposed according to the invention.

A pressure control valve 20 shown in a sectional view in FIG. 3 includes a mounting element 74 with an external thread that is secured to a housing 22 for example by means of a support ring 68. By means of this mounting element 74, which is affixed in the axial direction by means of the support ring 68 on the circumference of the housing 22 of the pressure control valve 20 proposed according to the invention, the pressure control valve 20 is mounted in a high-pressure accumulator body 72 that is only partially depicted in FIG. 3. The screw connection between an internal thread in the high-pressure accumulator body 72 at the mounting location produces a pressure-tight connection between the pressure control valve 20 proposed according to the invention and the inside of the high-pressure accumulator body 72 (common rail). System pressures of up to 2000 bar and more prevail in this high-pressure accumulator body 72. The system pressure p in the high-pressure accumulator body 72 is maintained by a high-pressure delivery unit not shown in FIG. 3, for example a high-pressure pump, independent of the speed of an internal combustion engine to be supplied with fuel.

FIG. 3 shows that the housing 22 of the pressure control valve 20 proposed according to the invention has an electrical connection 24 for electrically contacting the pressure control valve 20 proposed according to the invention. The housing 22 of the pressure control valve 20 proposed according to the invention contains an insert 26. This insert limits the stroke of an armature plate 34 of an armature assembly 32, which also includes an armature pin 50 that extends through an armature pin bore 52 of the housing 22 of the pressure control valve 20 proposed according to the invention.

The insert 26 is sealed against the housing 22 of the pressure control valve 20 proposed according to the invention by means of a first seal 28. The armature plate 34 accommodated on the armature pin 50 of the armature assembly 32 has a flat side 36 oriented toward an end surface 38 of the housing 22 of the pressure control valve 20. The flat side 36 of the armature plate 34 of the armature assembly 32 is acted on by a compression spring 30 that is accommodated in a bore in the end surface 38 of the housing 22 of the pressure control valve 20. The housing 22 of the pressure control valve 20 also accommodates a magnet coil 46 that is embedded in the housing 22 of the pressure control valve 20, enclosed by a bedding 44. The pressure control valve shown in a sectional view in FIG. 3 is characterized by the fact that a volume, which is defined by the flat side 36 of the armature plate 34 on one side and by the end surface 38 of the housing 22 on the other, is a reduced volume 40. The volume, which is discharged from the high-pressure region of the high-pressure accumulator body 72 when a valve element 54 opens, flows into the discharge chamber represented by this reduced volume 40, thus filling this reduced volume 40. A reduction of this volume between the armature assembly 32 and the end surface 38 of the housing 22 and the filling of it with the medium discharged from the high-pressure side do in fact permit medium to travel into this volume, but because of the reduced volume 40 and the consequently reduced hydraulic forces, this leads to an improved stability of the pressure control valve 20, particularly in the presence of elevated backpressures. This is particularly evident from the steady curves 16 of the respective characteristic diagrams 12 of the pressure/flow characteristic map in 10 shown in FIG. 2. In order to be able to embody a nonmagnetic gap 48, which determines the pressure/flow characteristic diagram of the pressure control valve 20 proposed according to the invention, in a large enough size in spite of a very small air gap, the reduced volume 40 between the armature plate 34 and the end surface 38 of the housing 22 is preferably filled with a filling volume 42 composed of a nonmagnetic material. This further increases the robustness of the resistance to the occurrence of instabilities 14 depicted by the characteristic diagram curves 12 in FIG. 1. In the ideal case, no air gap remains when the pressure control valve 20 is closed; the entire nonmagnetic gap 48 is filled with nonmagnetic material, i.e. the filling volume 42. In actual practice, however, a small air gap due to production tolerances remains even when the pressure control valve 20 is closed, but this air gap is significantly reduced in comparison to the air gap that forms in pressure control valves according to the prior art and constitutes the volume that is filled by the discharged fuel.

As indicated in FIG. 3, the previously existing air gap between the flat side 36 of the armature plate 34 and the end surface 38 of the housing 22 can be filled with a nonmagnetic material, i.e. the filling volume 42, by means of applying a film or a coating to the flat side 36 of the armature plate 34 or to the end surface 38 of the housing 22. This coating or fihn can also be applied to the flat side 36 of the armature plate 34 and/or to the end surface 38 of the housing 22. It is then possible for the remaining residual air gap in the closed pressure control valve 20 to have an extremely small volume.

As is also evident from the depiction in FIG. 3, the armature pin 50 of the armature assembly 32 extends through the armature pin bore 52 in the housing 22 of the pressure control valve 20 proposed according to the invention. The tip of the armature pin 52 oriented toward the high-pressure accumulator body 72 is conically embodied and actuates a valve element 54 that is embodied in the form of a ball in the embodiment of the pressure control valve 20 proposed according to the invention shown in FIG. 3. The armature pin 50 moves this valve element 54, which is ball-shaped in this embodiment, into its seat 56, which is embodied in a seat ring 58. The seat ring 58 is embodied at the end of the housing 22 of the pressure control valve 20 proposed according to the invention situated opposite the cavity, i.e. the region of the high-pressure accumulator 52 that is acted on with system pressure p. The seat ring 58 has a conduit 60 extending through it, via which fuel from the cavity of the high-pressure accumulator body (common rail) is supplied via a filter screen 62. Depending on the system pressure p prevailing on the inside of the high-pressure accumulator body 72, when a certain maximum pressure is exceeded, e.g. in the event of pressure pulsations, the pressure in the high-pressure accumulator body 72 is relieved via the pressure control valve 20 according to the sectional depiction in FIG. 3. When the valve element 74 is open, the fuel volume discharged via the conduit 60 and seat 56 into discharge lines 70 is returned to the tank of the high-pressure accumulator injection system via a return on the low-pressure side. In other embodiments of fuel injection systems, it is also possible for the return not to lead directly into the tank, but for it to feed back in again downstream of a presupply pump likewise provided in fuel injection systems, thus producing higher backpressures.

As is also evident from the depiction in FIG. 3, between the seat ring 58, in which the seat 56 is provided for the valve element 54 embodied in the form of a ball, can be preceded by a washer 64 in order to compensate for production tolerances. Furthermore, an additional, second seal is situated on the circumference surface of the housing 22 of the pressure control valve 20, between the discharge line 70 and the support ring 68 for fixing the mounting element 74 in position.

In the pressure control valve 20 proposed according to the invention, the greater robustness and the avoidance of discontinuities and instabilities 14 in the characteristic diagram curve 12 is achieved in that the volume previously existing in pressure control valves 20 between the flat side 36 of the armature plate 34 the end surface 38 of the housing 22 is reduced by means of the filling volume 42, which is preferably represented by a nonmagnetic material. Because of the reduced volume 40, which is then still filled by the discharged medium, it is possible to achieve a considerable reduction of the hydraulic forces that would have otherwise been in effect in the volume between the armature plate 34 the end surface 38 of the housing 22, which in turn improves the precision of the actuation of the armature assembly 32. In order to be able to embody the nonmagnetic gap 48, which determines the pressure/flow characteristic diagram of the pressure control valve 20 proposed according to the invention, in a large enough size in spite of a small air gap, the remaining reduced volume 40 between the flat side 36 of the armature plate 34 and the end surface 38 of the housing 22 of the pressure control valve 20 is filled with the filling volume 42 composed of nonmagnetic material. This filling volume 42 can be implemented either in the form of a coating or in the form of an inserted film or the like. When the pressure control valve 20 proposed according to the invention is closed, a nonmagnetic gap 48 between the end surface 38 of the housing 22 and the flat side 36 of the armature plate 34 remains, which is reduced by the filling volume 42 so that hydraulic forces cannot cause the instabilities 14 in the pressure control valve 20 depicted in FIG. 1. When the pressure control valve 20 proposed according to the invention is in its open position as shown in FIG. 3, then the armature assembly 32 composed of the armature pin 50 and armature plate 34 is moved in the opening direction so that when the pressure control valve 20 is open, there is a slightly enlarged volume between the flat side 36 of the armature plate 34 and the end surface 38 of the housing 22 of the pressure control valve 20. But this volume is significantly reduced. According to the invention, the measure of embodying a reduced volume 40 can be carried out together with the insertion of the filling volume 42 between the flat side 36 of the armature plate and the end surface 38 of the housing 22 or only a reduction of the volume 40 can be carried out or an introduction of the filling volume 42 between the flat side 36 of the armature plate and the end surface 38 of the housing 22. In lieu of the two springs shown in FIG. 3, i.e. the compression spring 30 and the spring that acts on the armature plate 34, it is also possible for only one of these two springs to be provided, i.e. either only the compression spring 30 or only the spring accommodated in the insert 26 and acting on the rear side of the armature plate 34. Both possible installation positions are shown in FIG. 3.

The measures proposed according to the invention, i.e. the reduction of the volume 40 and the introduction of the filling volume 42 composed of nonmagnetic material, can also be implemented singly or in combination in solenoid valves that are used to actuate fuel injectors in fuel injection systems such as high-pressure accumulator (common rail) injection systems.

1-10. (canceled)

11. A pressure control valve, in particular for a high-pressure accumulator body or a high-pressure pump of a fuel injection comprising:
a housing having an end surface; and
an armature assembly with an armature plate and armature pin, in which the armature plate and the end surface of the housing constitute a volume that can be filled with a medium discharged from the high-pressure accumulator body, wherein the volume is reduced by the presence of a filling volume.

12. The pressure control valve as recited in claim 11, wherein the filling volume is a nonmagnetic material.

13. The pressure control valve as recited in claim 11, wherein the filling volume is introduced between a flat side of the armature plate and the end surface of the housing.

14. The pressure control valve as recited in claim 12, wherein the filling volume is embodied in the form of a film or a coating.

15. The pressure control valve as recited in claim 13, wherein the filling volume is embodied in the form of a film or a coating.

16. The pressure control valve as recited in claim 13, wherein the filling volume is embodied in the form of a film or a coating, which is applied to the flat side of the armature plate or is inserted between the flat side and the end surface of the housing.

17. The pressure control valve as recited in claim 14, wherein the filling volume embodied in the form of a film or a coating is applied to a flat side of the armature plate or is inserted between the flat side and the end surface of the housing.

18. The pressure control valve as recited in claim 15, wherein the filling volume embodied in the form of a film or a coating is applied to the flat side of the armature plate or is inserted between the flat side and the end surface of the housing.

19. The pressure control valve as recited in claim 13, wherein the filling volume is embodied in the form of a film or a coating, which is applied to the end surface of the housing.

20. The pressure control valve as recited in claim 14, wherein the filling volume embodied in the form of a film or a coating is applied to the end surface of the housing.

21. The pressure control valve as recited in claim 15, wherein the filling volume embodied in the form of a film or a coating is applied to the end surface of the housing.

22. The pressure control valve as recited in claim 13, wherein a nonmagnetic gap remains between the filling volume and the flat side of the armature plate or the end surface of the housing.

23. The pressure control valve as recited in claim 14, wherein a nonmagnetic gap remains between the filling volume and a flat side of the armature plate or the end surface of the housing.

24. The pressure control valve as recited in claim 16, wherein a nonmagnetic gap remains between the filling volume and the flat side of the armature plate or the end surface of the housing.

25. The pressure control valve as recited in claim 19, wherein a nonmagnetic gap remains between the filling volume and the flat side of the armature plate or the end surface of the housing.

26. The pressure control valve as recited in claim 11, wherein a volume in an insert of the housing in which the armature plate of the armature assembly is accommodated, is decoupled from the volume reduced by the filling volume, into which the medium is discharged from the high-pressure accumulator.

27. The pressure control valve as recited in claim 13, wherein a volume in an insert of the housing in which the armature plate of the armature assembly is accommodated, is decoupled from the volume reduced by the filling volume, into which the medium is discharged from the high-pressure accumulator.

28. The pressure control valve as recited in claim 11, wherein a system pressure of at least 1500 bar prevails in the high-pressure accumulator body while the pressure prevailing in a discharge line prevails in the housing of the pressure control valve.

29. The pressure control valve as recited in claim 13, wherein a system pressure of at least 1500 bar prevails in the high-pressure accumulator body while the pressure prevailing in a discharge line prevails in the housing of the pressure control valve.

30. The pressure control valve as recited in claim 11, wherein the pressure control valve is situated in a fuel injection system, in particular a high-pressure accumulator injection system.
